(19) United States
(12) Patent Application Publication
(10) Pub. No.: US 2022/0172131 A1
(43) Pub. Date: Jun. 2, 2022

(54) RESOURCE ALLOCATION DEVICE, RESOURCE ALLOCATION METHOD, AND RESOURCE ALLOCATION PROGRAM

(71) Applicant: NIPPON TELEGRAPH AND TELEPHONE CORPORATION, Tokyo (JP)

(72) Inventors: Naoko KOSAKA, Tokyo (JP); Tomohiro KOKOGAWA, Tokyo (JP)

(73) Assignee: NIPPON TELEGRAPH AND TELEPHONE CORPORATION, Tokyo (JP)

(21) Appl. No.: 17/601,023

(22) PCT Filed: Mar. 18, 2020
(86) PCT No.: PCT/JP2020/012021

§ 371 Date: Oct. 1, 2021

(30) Foreign Application Priority Data
Apr. 4, 2019 (JP) 2019-072313

(51) Int. Cl. G06Q 10/06; G06Q 50/26

(52) U.S. Cl. CPC G06Q 10/06; G06Q 50/26

(57) ABSTRACT

A resource allocation apparatus (10) classifies a task created from a crisis response operation plan into any of a plurality of missions set based on a critical function in the event of a crisis event, estimates a risk for each mission or for each team that performs the task based on the progress of the task classified into the mission, and creates a resource allocation scenario according to the estimated risk.

### TECHNICAL FIELD

The present invention relates to a resource allocation apparatus, a resource allocation method and a resource allocation program.

### BACKGROUND ART

Today, with the frequent occurrence of major disasters and cyberattacks, organizations are placing a premium on business continuity, and the society has recognized the need for business continuity planning (BCP). An operation plan formulated as disaster planning describes a recovery process and the priority in recovery. However, in the event of a major crisis event, resources are overwhelmed, so that recovery activities need to be effectively and efficiently performed by estimating risks from various viewpoints and determining the priority in recovery to reduce the risks.

In prior art, business plan formulation methods and risk assessment methods that combine the business flow diagram (BFD) and the critical path method (CPM) have been developed (see Non-Patent Literatures 1 and 2, for example). Furthermore, a method is under study that creates a dynamic scenario based on the strengths weaknesses opportunities threats (SWOT) analysis according to the integration definition 0 (IDEF0) operation process modeling to determine the response to a change of situation (see Non-Patent Literature 3, for example).

On the other hand, as techniques for supporting the crisis response after a risk manifests itself, there are a mechanism for managing a delay or backlog in the management of the progress of a crisis response operation (see Patent Literature 1, for example), a mechanism for classifying and presenting an activity log from a new viewpoint needed by the disaster response headquarters rather than by the crisis site (see Patent Literature 2, for example), and a mechanism for presenting the know-how acquired from similar past events as well as similar problems and solutions to the problems (see Patent Literature 3, for example).

### CITATION LIST

### Patent Literature

Patent Literature 1: Japanese Patent Laid-Open No. 2016-224671
Patent Literature 2: Japanese Patent Laid-Open No. 2016-212799
Patent Literature 3: Japanese Patent Laid-Open No. 2015-230624

### Non-Patent Literature

Non-Patent Literature 1: “Development of Business Continuity Plan for Maintaining Expressway Functions by Applying Both business flow diagram (BFD) and critical path method (CPM)”, Akira Okamoto, et al., Journal of Social Safety Science, No. 20, July 2013
Non-Patent Literature 2: “Development of Risk Management Method on Expressways”, Akira Okamoto et al., Journal of Social Safety Science, No. 27, November 2015
Non-Patent Literature 3: “Fundamental Study on Dynamic Scenario Generation for Situation Management”, Yuki Hamada et al., Journal of International Association of P2M, Vol. 9, No. 2, pp. 237-254, 2015

### SUMMARY OF THE INVENTION

### Technical Problem

However, the conventional techniques described above have the following problem: an efficient recovery plan may be unable to be formulated. For example, the conventional techniques described above have no mechanism that estimates risks by analyzing the crisis response operation after a risk manifests itself and allocates resources based the estimated risks, and therefore have the following problem: an efficient recovery plan cannot be formulated.

### Means for Solving the Problem

To solve the problem described above and attain an object, a resource allocation apparatus according to the present invention includes: a mission classification part that classifies a task created from a crisis response operation plan into any of a plurality of missions set based on a critical function in the event of a crisis event; a risk estimation part that estimates a risk for each mission or for each team that performs the task based on a progress of the task classified into the mission by the mission classification part; and a resource allocation part that creates a resource allocation scenario according to the risk estimated by the risk estimation part.

A resource allocation method according to the present invention is a resource allocation method performed by a resource allocation apparatus, including: a mission classification process of classifying a task created from a crisis response operation plan into any of a plurality of missions set based on a critical function in the event of a crisis event; a risk estimation process of estimating a risk for each mission or for each team that performs the task based on a progress of the task classified into the mission in the mission classification process; and a resource allocation process of creating a resource allocation scenario according to the risk estimated in the risk estimation process.

A resource allocation program according to the present invention makes a computer perform: a mission classification step of classifying a task created from a crisis response operation plan into any of a plurality of missions set based on a critical function in the event of a crisis event; a risk estimation step of estimating a risk for each mission or for each team that performs the task based on a progress of the task classified into the mission in the mission classification step; and a resource allocation step of creating a resource allocation scenario according to the risk estimated in the risk estimation step.

### Effects of the Invention

According to the present invention, an efficient recovery plan can be advantageously formulated.

### BRIEF DESCRIPTION OF DRAWINGS

FIG. 1 is a diagram for illustrating a configuration of a risk management system.

FIG. 2 is a diagram showing an example of a mission pack.

FIG. 3 is a diagram showing an example of a risk factor.

FIG. 4 is a diagram showing an example of a risk extraction condition.

FIG. 5 is a diagram showing an example of a to-do list displayed on a screen.

FIG. 6 is a diagram for illustrating responsible teams in the to-do list.

FIG. 7 is a diagram showing an example of a task displayed on a screen.

FIG. 8 is a diagram for illustrating a process of classifying tasks into missions.

FIG. 9 is a diagram showing an example of a link in a mission pack.

FIG. 10 is a diagram for illustrating an example of a process of estimating a risk based on the response statuses of tasks.

FIG. 11 is a diagram for illustrating an example of a process of estimating a risk based on the priorities of tasks.

FIG. 12 is a diagram for illustrating a resource allocation process.

FIG. 13 is a diagram showing an example of a resource allocation plan.

FIG. 14 is a diagram showing an example of a resource allocation scenario displayed.

FIG. 15 is a diagram for illustrating an overview of the whole of a process performed by the risk management system.

FIG. 16 is a sequence diagram showing an example of a flow of a process performed by a risk management system according to a first embodiment.

FIG. 17 is a diagram showing a computer that executes a resource allocation program.

### DESCRIPTION OF EMBODIMENTS

In the following, a resource allocation apparatus, a resource allocation method and a resource allocation program according to an embodiment of the present application will be described in detail with reference to the drawings. This embodiment is not intended to limit the resource allocation apparatus, the resource allocation method and the resource allocation program according to the present application.

### First Embodiment

In the following, a configuration of a risk management system 1 including a resource allocation apparatus 10 according to a first embodiment and a flow of a process performed by the risk management system 1 will be described, and advantages of the first embodiment will then be described.

[Configuration of Risk Management System]

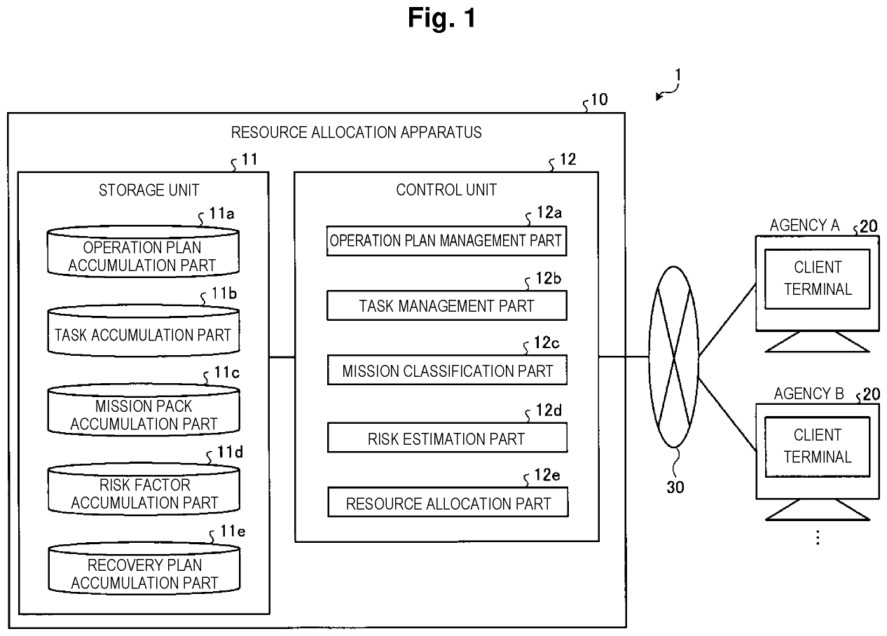

FIG. 1 is a diagram for illustrating a configuration of the risk management system. As shown in FIG. 1, the risk management system 1 includes the resource allocation apparatus 10 and a plurality of client terminals 20 connected to each other over a network 30.

The resource allocation apparatus 10 is a server apparatus, for example. The resource allocation apparatus 10 sets a mission pack in advance based on critical functions and activity purposes in BCP, classifies tasks to be performed in a crisis response operation plan in crisis response on a mission basis, and manages the progress of a task on a mission basis. The resource allocation apparatus 10 estimates a risk, creates a resource allocation scenario based on the estimated risk, and reallocates resources based on the resource allocation scenario. The resource allocation apparatus 10 can perform such a cyclic process, thereby extracting a problem of a recovery operation from the viewpoint of BCP during progress of the recovery operation and reallocating resources.

The client terminal 20 is a personal computer, a smartphone or a cellular phone, for example. The client terminal 20 is provided in each agency (team) involved with crisis response, for example. A user can perform setting of an operation plan or a mission pack or registration of a task on a client terminal 20 via a web browser. The client terminal 20 also displays a management screen for an operation plan or a task, and a resource allocation scenario created by the resource allocation apparatus 10, for example.

The network 30 can be any network that connects apparatuses to each other in such a manner that the connected apparatuses can communicate with each other, such as the Internet, a local area network (LAN) or a wide area network (WAN).

[Configuration of Resource Allocation Apparatus]

Next, a configuration of the resource allocation apparatus 10 will be described in detail. As shown in FIG. 1, the resource allocation apparatus 10 includes a storage unit 11 and a control unit 12. The storage unit 11 is implemented by a semiconductor memory element such as a random access memory (RAM) or a flash memory, or a storage device such as a hard disk drive or an optical disk drive, and stores a processing program for operation of the resource allocation apparatus and data used during execution of the processing program, for example. The storage unit 11 includes an operation plan accumulation part 11a, a task accumulation part lib, a mission pack accumulation part 11c, a risk factor accumulation part 11d and a recovery plan accumulation part 11e.

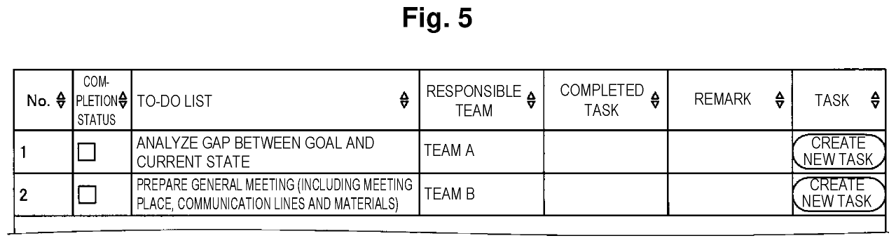

The operation plan accumulation part 11a stores information concerning an operation plan for crisis response. For example, operation plan accumulation part 11a stores things to be performed in an operation plan in the form of a checklist. As items of the checklist, for example, the operation plan accumulation part 11a stores an identification number of a checklist item, a completion status, a to-do list, a responsible team, a completed task and a remark. An example of the checklist displayed on a screen will be described later with reference to FIG. 5.

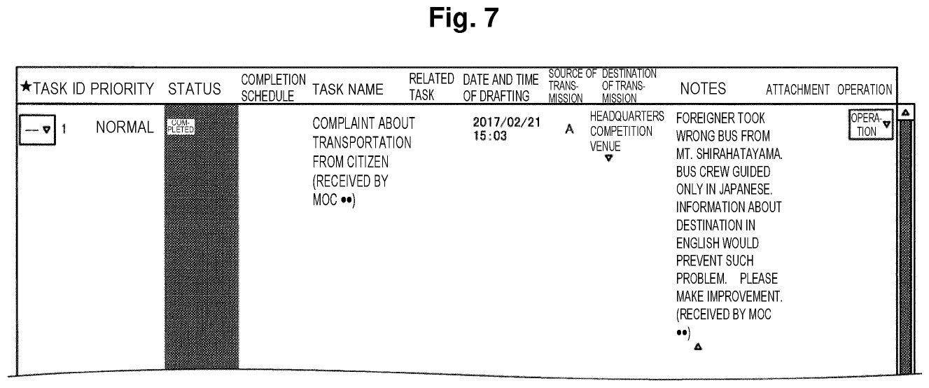

The task accumulation part 11b stores a task drafted in association with a checklist item. As task items, for example, the task accumulation part 11b stores a task ID, a priority, a status, a completion schedule, a task name, a date and time of drafting, a source of transmission, a destination of transmission and notes. An example of a task displayed on a screen will be described later with reference to FIG. 7.

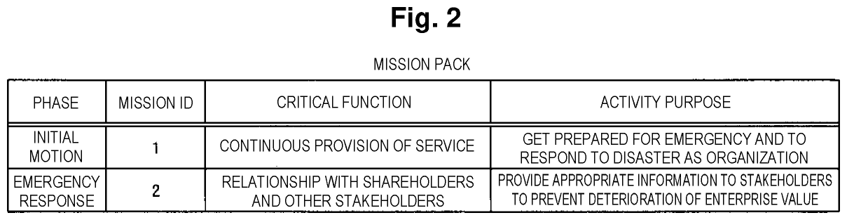

The mission pack accumulation part 11c stores a “critical function” after the occurrence of a crisis event and an “activity purpose” associated therewith that are set in advance as a mission pack. As illustrated in FIG. 2, for example, the mission pack accumulation part 11c stores a “phase” after the occurrence of a crisis event, a “mission ID” for identifying a mission, a “critical function” after the occurrence of a crisis event, and an “activity purpose” after the occurrence of a crisis event that are in association with each other. FIG. 2 is a diagram showing an example of the mission pack.

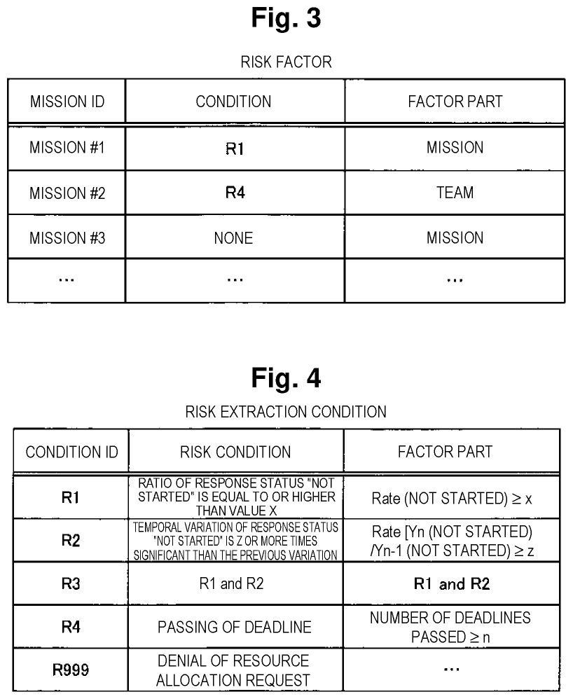

The risk factor accumulation part 11d stores a risk factor, which is a risk factor of a mission, and a risk extraction condition, which is a condition for extracting a risk. As illustrated in FIG. 3, the risk factor accumulation part 11d stores a “condition” that indicates a condition ID of a relevant risk condition and a “factor part” in which a risk originates in association with each other for each mission ID. If a risk is extracted on a mission basis, the “factor part” is “mission”, and if a risk is extracted on a team basis, the “factor part” is “team”. A risk estimation process will be described later with regard to a risk estimation part 12d.

As illustrated in FIG. 4, as risk extraction conditions, the risk factor accumulation part 11d also stores a “condition ID”, a “risk condition”, which is a condition for extracting a risk, and a “risk condition formula”, which is a condition formula for extracting a risk, in association with each other.

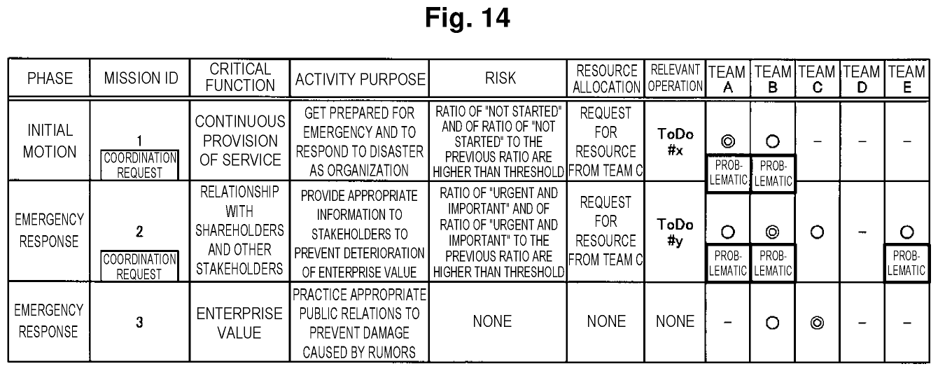

The recovery plan accumulation part 11e stores a resource allocation scenario for making a plan to allocate resources from a team having resources to spare. For example, as a resource allocation scenario, the recovery plan accumulation part 11e stores a team to be requested for a resource for each mission. An example of a resource allocation scenario displayed on a screen will be described later with reference to FIG. 14.

Next, the control unit 12 will be described. The control unit 12 has an internal memory that stores a program describing various procedures and required data, and performs various processes according to the program and the data. For example, the control unit 12 is an electronic circuit, such as a central processing unit (CPU) or a micro processing unit (MPU). The control unit 12 includes an operation plan management part 12a, a task management part 12b, a mission classification part 12c, a risk estimation part 12d and a resource allocation part 12e.

The operation plan management part 12a reads an operation plan (checklist) and manages the progress of the checklist based on the progress of tasks linked with the items in the checklist. The operation plan is created by the user in advance and stored in the operation plan accumulation part 11a.

The operation plan management part 12a reads data of a checklist, as illustrated in FIG. 5, from the operation plan accumulation part 11a in response to a request from a client terminal 20 or the like, and displays the checklist. A plurality of tasks can be created from each checklist item (in a row), and the “completed task” column indicates the statuses of tasks. When the “create new task” in the checklist is selected by a user when a crisis event occurs, for example, the operation plan management part 12a accepts the drafting of a task by the user and issues a task registration request to the task management part 12b described later.

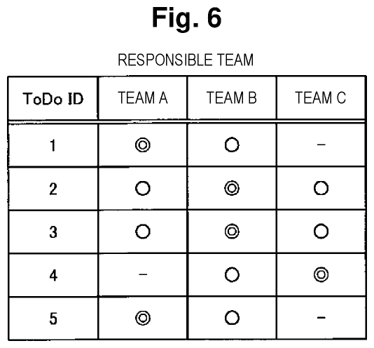

When all the tasks of the relevant item are completed, the operation plan management part 12a updates the “completion status” of the relevant item to indicate the completion. In crisis response, flexible response is needed, so that manual setting is allowed. The “responsible team” in the checklist may indicate one team assigned to a to-do when the team is small or may indicate a primary responsible team and a secondary responsible team when the teams are large or the operation is complicated, as illustrated in FIG. 6. In the example in FIG. 6, a double circle indicates a primary responsible team, a single circle indicates a secondary responsible team, and the other teams are not in charge. For example, for a to-do ID (which corresponds to “No.” in FIG. 5) of a checklist item of “1”, a team A is the primary responsible team, a team B is the secondary responsible team, and a team C is not in charge.

The task management part 12b stores a task in the task accumulation part 11b. For example, when the task management part 12b receives a task registration request from the operation plan management part 12a, the task management part 12b stores a task in the task accumulation part 11b. The task management part 12b also manages the priority or progress of a task drafted in association with an item in the checklist according to a flag (response status, priority, or due date) assigned to the task, and updates data of the task stored in the task accumulation part 11b.

In response to a request from a client terminal 20 or the like, the task management part 12b also reads data of a task from the task accumulation part 11b and displays the task as illustrated in FIG. 7. For example, when a report or other message concerning a task is exchanged after the task is drafted, the task management part 12b manages the message in association with the task as a thread, and updates the data of the task stored in the task accumulation part 11b. As a flag of a task, four levels of priority (urgent and important, important, urgent, and normal) and four levels of status (not started, in progress, completed, and informed) can be set. These levels can be automatically or manually changed as required according to the status of the task.

As a user presetting process, the mission classification part 12c sets a “critical function” after the occurrence of a crisis event and a “activity purpose” associated therewith as a mission pack, and stores the mission pack in the mission pack accumulation part 11c. The mission classification part 12c also classifies a task created from a crisis response operation plan into any of a plurality of missions set based on a critical function after the occurrence of a crisis event.

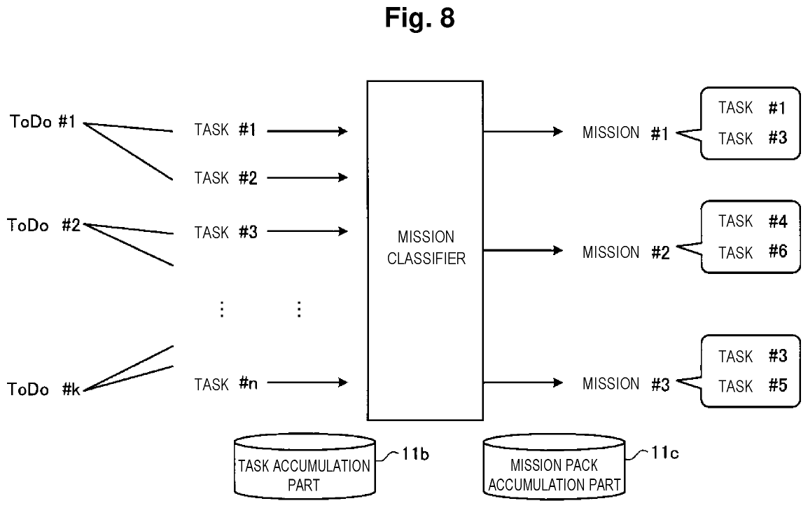

Specifically, as illustrated in FIG. 8, the mission classification part 12c classifies tasks stored in the task accumulation part 11b into missions read from the mission pack accumulation part 11c. In the example in FIG. 8, the mission classification part 12c classifies a task #1 and a task #3 into a mission #1, classifies a task #4 and a task #6 into a mission #2, and classifies a task #3 and a task #5 into a mission #3.

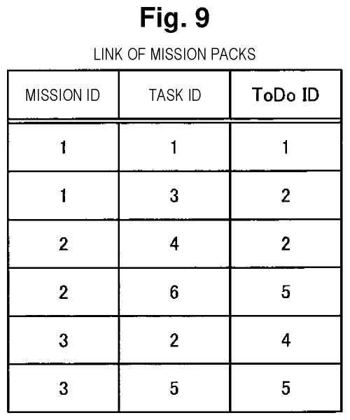

The mission classification part 12c classifies tasks into missions based on the contents described in the tasks using a mission classifier obtained in advance by learning using natural language processing, for example. As illustrated in FIG. 9, the mission classification part 12c may also store information including a “mission ID” of a mission, a “task ID” of a task and a “to-do ID” of a checklist item linked with each other in the mission pack accumulation part 11c. This allows reverse lookup of a to-do from a mission pack and determination of a responsible team for the to-do. The recovery area may have a significance in some cases, missions may be further classified on an area basis.

Based on the progress of a task classified into each mission by the mission classification part 12c, the risk estimation part 12d estimates a risk for each mission or for each team to perform the task. For example, the risk estimation part 12d extracts a risk of each mission based on the number of tasks that are not started, a temporal variation of the number of tasks that are not started, and the number of tasks whose deadlines have passed as the progress of tasks.

For example, the risk estimation part 12d reads a risk extraction condition set previously from the risk factor accumulation part 11d, determines whether information on tasks stored in the mission pack accumulation part 11c satisfies the risk extraction condition, extracts any task that satisfies the risk extraction condition as a mission having a problem of a delay or backlog, and stores the task in the risk factor accumulation part 11d. The risk estimation part 12d also extracts a team having a problem of a delay or backlog and stores the team in the risk factor accumulation part 11d.

For example, the risk estimation part 12d uses the risk extraction condition to extract a part of a task classified into a mission that has a problem with a breakdown or temporal variation of the flag or a problem of passing of the deadline or the like, and stores a risk condition relevant to each mission in the risk factor accumulation part 11d as a risk factor. The risk estimation part 12d also extracts a team having a problem of a delay or backlog and stores the team in the risk factor accumulation part. When the risk estimation part 12d extracts a risk on a mission basis, the factor part of the risk factor is “mission”, and when the risk estimation part 12d extracts a risk on a team basis, the factor part of the risk factor is “team”.

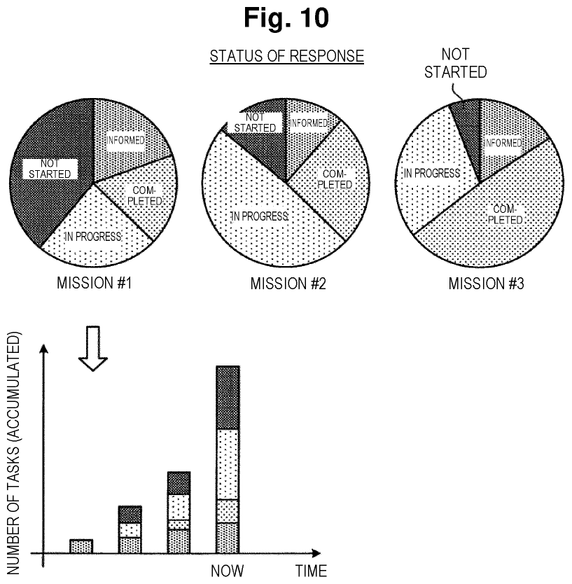

With reference to FIG. 10, an example of a process of estimating a risk based on the response statuses of tasks will be described. FIG. 10 is a diagram for illustrating a process of estimating a risk based on the response statuses of tasks. As illustrated in FIG. 10, for example, the risk estimation part 12d compiles the statuses “informed”, “completed”, “in progress” and “not started” as the response statuses of tasks for each of the missions #1 to #3, and analyzes the variation of the number of tasks in each response status. In the example in FIG. 10, for the mission #1, the number of tasks that are “not started” is high and further increases with time. Such a mission is estimated to have a risk and extracted as a problematic mission.

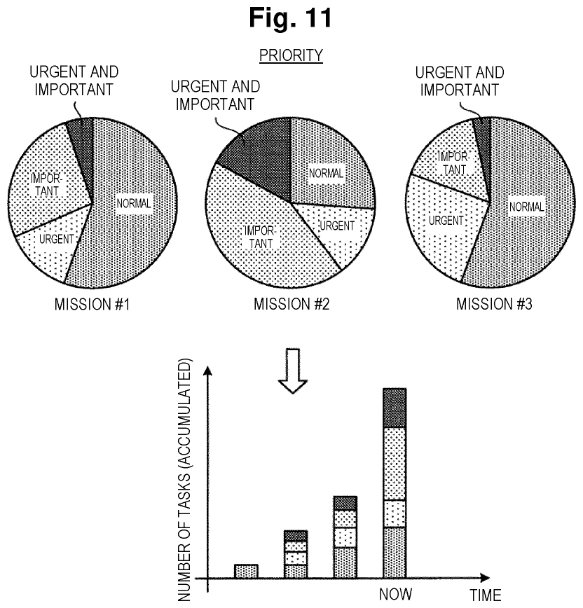

The risk estimation part 12d may estimate a risk based on the priorities of tasks. With reference to FIG. 11, an example of a process of estimating a risk based on the priorities of tasks will be described. FIG. 11 is a diagram for illustrating a process of estimating a risk based on the priorities of tasks. As illustrated in FIG. 11, for example, the risk estimation part 12d compiles the priorities “normal”, “urgent”, “important” and “urgent and important” as the priorities of tasks for each of the missions #1 to #3, and analyzes the variation of the number of tasks for each priority. In the example in FIG. 11, for the mission #2, the number of tasks that have a priority “urgent and important” is high and further increases with time. Such a mission is estimated to have a risk and extracted as a problematic mission.

The resource allocation part 12e creates a resource allocation scenario based on a risk estimated by the risk estimation part 12d. Specifically, the resource allocation part 12e creates an allocation scenario that allocates a resource to a mission determined to have a risk based on a risk estimated by the risk estimation part 12d. For example, the resource allocation part 12e determines that missions involved with a responsible team for a problematic mission extracted by the risk estimation part 12d, a responsible team for a task classified into the problematic mission and a team having a problem with the progress of a task have a potential risk, creates a scenario that allocates a resource to the missions, and stores the scenario in the recovery plan accumulation part 11e.

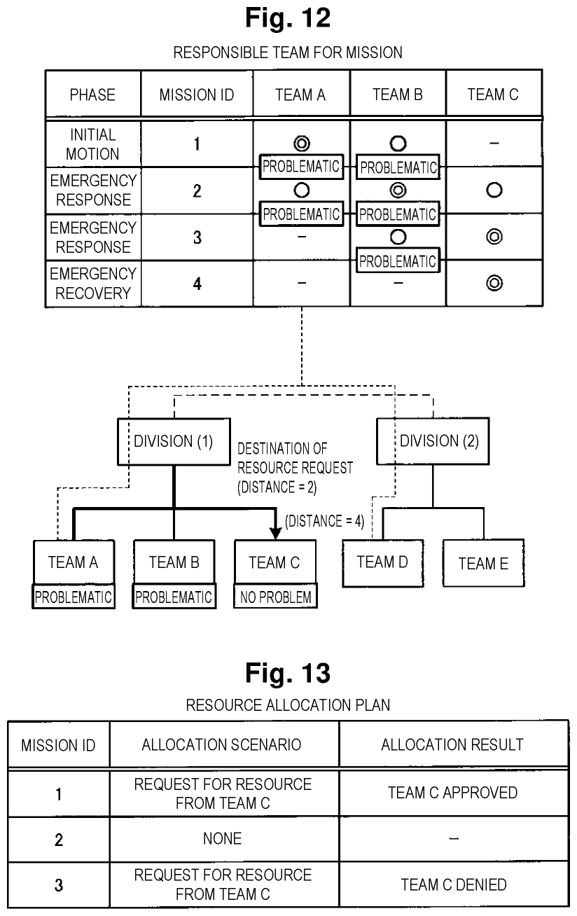

For example, the resource allocation part 12e checks the relationship between a responsible team for a problematic mission stored in the risk factor accumulation part 11d and a responsible team for a task classified into the mission, and make a plan to allocate resources of another responsible team or a team having a resource to spare. Here, with reference to an example shown in FIG. 12, a resource allocation process will be described. FIG. 12 is a diagram for illustrating a resource allocation process. For example, when a mission having a mission ID of “1” is detected as a problematic mission, the resource allocation part 12e checks a risk estimation result for a team A and a team B, which are responsible teams, in the risk factor accumulation part 11d. If the team A and the team B have no problem, the resource allocation part 12e issues directions to continue the resource allocation with the team A and the team B.

When the team A or the team B has a problem, if any one of the responsible teams has a problem, and the other has no problem, the resource allocation part 12e directs the other responsible team to allocate more resources. If both the responsible teams have a problem, the resource allocation part 12e requests a resource from another team having no problem. In the example shown in FIG. 12, both the responsible team A and the responsible team B have a problem. As illustrated in FIG. 12, when requesting a resource from another team having no problem, a team is selected that is not in charge in the relevant phase and is close to the responsible teams in the organization. In the example in FIG. 12, a team C, which belongs to the same division as the team A and the team B, is selected.

Specifically, a team is selected based on the distance from the responsible teams in the organization chart. This is because a team having a similar jurisdiction would be more likely to accommodate the request. Here, the term “distance” means the number of the teams between the relevant two teams in the organization chart illustrated in FIG. 12. For example, as illustrated in FIG. 12, if the teams C, D and E are not in charge, the team C, which is the closest to the responsible teams A and B in the organization chart, is selected.

For a problematic team stored in the risk factor accumulation part, the resource allocation part 12e determines that a mission for which the team is responsible has a potential risk and allocates a resource of a team having a resource to spare as in the case where a problematic mission is directly extracted. When a plurality of missions has a problem or is extracted as having a potential problem, the resource allocation part 12e may preferentially allocate resources to missions in earlier response phases. That is, even if there is a competition in a resource allocation result, a preference is given to missions in earlier response phases. The resource allocation part 12e presents not only the resource allocation but also the number of the to-do list to which the relevant task belongs as an operation to which a resource is allocated.

As illustrated in FIG. 13, the resource allocation part 12e may create a resource allocation plan that associates an allocation scenario and an allocation result with each other for each mission ID, and communicate the resource allocation plan to the operation plan management part 12a.

When receiving the resource allocation plan, the operation plan management part 12a performs a risk estimation to check a problematic mission in advance of a policy decision by a headquarters meeting or the like, and presents a resource allocation scenario to the client terminal 20 of each team. Presenting the resource allocation scenario can facilitate understanding of the need for resource provision and the validity of the request for support and therefore smooth coordination between teams.

For example, in a specific flow, the risk estimation part 12d determines the mission #1 to be a problematic mission because the ratio of the tasks that are not started is equal to or higher than a threshold, and determines the responsible teams A and B responsible for the mission #1 to be problematic teams. Furthermore, the risk estimation part 12d determines the mission 2, for which the teams A and B are responsible, to be a potential problematic mission. The resource allocation part 12e makes a plan to request another team C having no problem to provide a resource to the mission #1, makes a similar plan for the other problematic missions, and presents the plans as a resource allocation scenario. Here, with reference to an example shown in FIG. 14, an example of a resource allocation scenario displayed will be described. FIG. 14 is a diagram for illustrating adjustments of a resource allocation scenario. As illustrated in FIG. 14, in the resource allocation scenario, teams to be requested to provide a resource and whether each team has a problem or not can be checked. On the resource allocation scenario, as illustrated in FIG. 14, an indicator of a problematic team is shown, and a “request for coordination” function for requesting coordination with an associated team for solving a problem is provided.

The “request for coordination” function will now be described with regard to a specific example. First, when a “request for coordination” is performed for the mission of the mission ID of “1”, for example, the team C is requested to provide a resource. In response to the request, the team C accommodates the request for a resource. After that, the operation plan management part 12a requests the team C, which has no problem, to provide a resource in order to avoid the risk of the mission 2. However, the team C denies the request because the team C has already provided a resource to the mission #1. Since the team C has denied the request, the operation plan management part 12a then requests a resource from another responsible team E. The operation plan management part 12a requests a resource from each team in this way, and allocates the resource if the request is accommodated.

As described above, the resource allocation apparatus 10 in the risk management system 1 sets a mission pack including critical functions and activity purposes in BCP in advance, classifies tasks to be performed in the crisis response operation plan into missions in crisis response, and manages the progress of the tasks on a mission basis. The resource allocation apparatus 10 then estimates a risk and reallocates resources. Through this cycle, the resource allocation apparatus 10 can extract a problematic part of a recovery operation from the viewpoint of BCP as the operation progresses and reallocate resources, and therefore can formulate an efficient recovery plan.

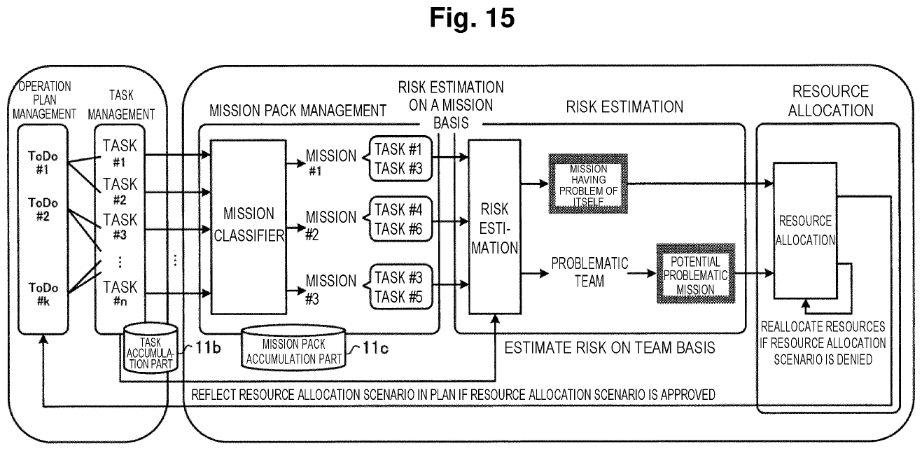

Next, with reference to FIG. 15, an overview of the whole of a process performed by risk management system 1 will be described. FIG. 15 is a diagram for illustrating an overview of the whole of a process performed by the risk management system. The resource allocation apparatus 10 in the risk management system 1 manages the progress of a checklist based on the progress of a task linked with an item in the checklist. That is, the resource allocation apparatus 10 manages the progress of an operation with respect to a goal of an operation plan set in advance.

The resource allocation apparatus 10 classifies tasks to be performed in the crisis response operation plan into missions, and estimates a risk on a mission or team basis. The resource allocation apparatus 10 extracts a mission having a problem of itself or a potential problematic mission that is to be dealt with by a problematic team, and creates a resource allocation scenario. If the resource allocation scenario is approved, the resource allocation apparatus 10 reflects the resource allocation scenario in the operation plan. If the resource allocation scenario is denied, the resource allocation apparatus creates another resource allocation scenario.

In this way, in advance of a policy decision by a headquarters meeting or the like, the risk management system 1 can summarize the status of the activity cycle so far according to a policy-based axis (missions) to extract a problem (or estimate a risk), create a resource allocation scenario to reduce the risk in the subsequent activity cycle and reflect the resource allocation scenario in a plan.

[Flow of Process Performed by Risk Management System]

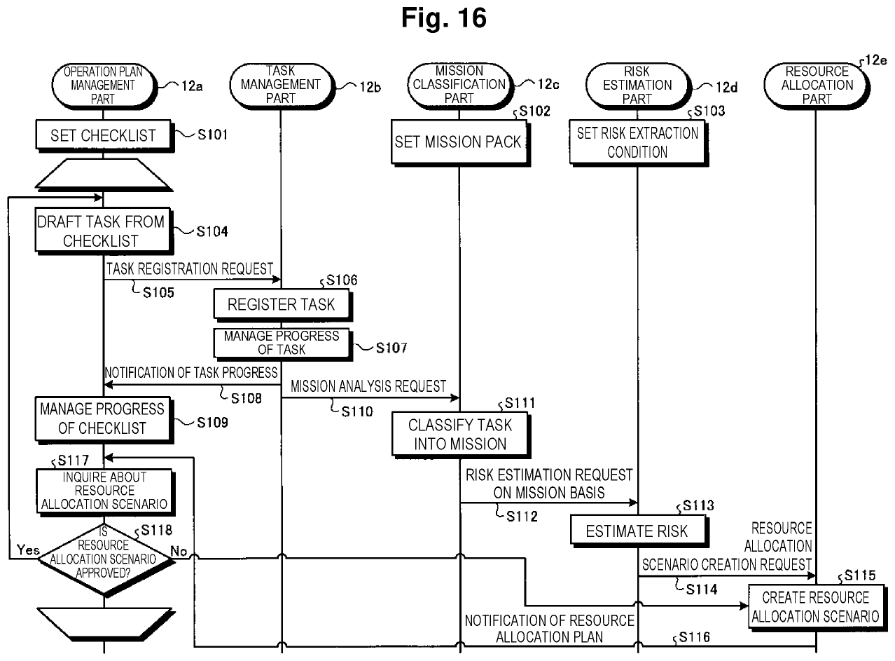

Next, with reference to FIG. 16, a flow of a process performed by the risk management system 1 according to the first embodiment will be described. FIG. 16 is a sequence diagram showing an example of a flow of a process performed by the risk management system according to the first embodiment.

As illustrated in FIG. 16, as a user presetting process, the operation plan management part 12a sets a checklist of things to be performed in an operation plan (Step S101), the mission classification part 12c sets a mission pack (Step S102), and the risk estimation part 12d sets a risk extraction condition (Step S103).

In the risk management system 1, after a crisis event occurs, when a task is drafted from the checklist by a user (Step S104), the operation plan management part 12a issues a task registration request to the task management part 12b (Step S105). In this example, the task is drafted from the checklist for the operation plan set in advance.

When receiving the task registration request from the operation plan management part 12a, the task management part 12b registers the task with the task accumulation part 11b (Step S106). The task management part 12b then manages the priority or progress of the task based on a flag (response status, priority or due date) assigned to the task drafted in association with an item in the checklist (Step S107), and notifies the operation plan management part 12a of the progress of the task (Step S108).

When receiving the progress of the task from the task management part 12b, the operation plan management part 12a manages the progress of the checklist according to the progress of the task (Step S109). The task management part 12b also issues a mission analysis request to the mission classification part 12c at a predetermined timing (Step S110).

The mission classification part 12c classifies the task into any of a plurality of missions set based on a critical function in the event of a crisis event (Step S111). The mission classification part 12c then requests the risk estimation part 12d to perform risk estimation on a mission basis (Step S112).

When receiving the risk estimation request, the risk estimation part 12d estimates a risk for each mission or each team that performs the task based on the progress of the task (Step S113), and requests the resource allocation part 12e to create a resource allocation scenario (Step S114).

When receiving the request for creation of a resource allocation scenario, the resource allocation part 12e creates a resource allocation scenario according to the risk estimated by the risk estimation part 12d (Step S115), and communicates a resource allocation plan to the operation plan management part 12a (Step S116).

The operation plan management part 12a then inquires each team whether to approve the resource allocation scenario (Step S117). If the resource allocation scenario is approved by each team (if affirmative in Step S118), the process returns to Step S104, where a task is automatically or manually drafted based on the resource allocation scenario. If the resource allocation scenario is not approved by all the teams (if negative in Step S118), the operation plan management part 12a requests the resource allocation part 12e to create another resource allocation scenario by taking the denied resource allocation scenario into account. The series of Steps S104 to S118 described above is repeated as far as the crisis response continues.

### Advantages of First Embodiment

The resource allocation apparatus 10 according to the first embodiment classifies tasks created from a crisis response operation plan into any of a plurality of missions set in advance based on critical functions in the event of a crisis event, estimates a risk on a mission basis or on the basis of teams that perform the tasks based on the progresses of the tasks classified into the missions, and creates a resource allocation scenario according to the estimated risk. Therefore, the resource allocation apparatus 10 can formulate an efficient recovery plan.

Provided that crisis response teams are divided into an administration level, a management level and a site level, the administration level makes decisions from the viewpoint of business continuity based on BCP, and the site level makes decisions from the viewpoint of preventing the advancement of damage and recovering from damage as soon as possible. In such a situation, when summarizing the status of the activity cycle so far and setting a goal of the subsequent activity cycle at a timing of a policy decision by a headquarters meeting or the like, the management level serves to read the reports on the recovery operations from the site level from the viewpoint of business continuity for the administration level and request the administration level to make an appropriate policy decision, and serves to direct the site level to formulate a specific operation plan based on the new policy decided by the administration level.

To support the operation of the management level described above, directions as to resource allocation can be efficiently reflected in the recovery plan by reading the statuses of the operations involved with the recovery activity of the site level from the viewpoint of administration and enterprise value of the administration level and indicating where a risk of a delay or backlog is. To this end, in advance of a policy decision by a headquarters meeting or the like, the resource allocation apparatus 10 according to the first embodiment can summarize the status of the activity cycle so far according to a policy-based axis (missions) to extract a problem (or estimate a risk), create a resource allocation scenario to reduce the risk in the subsequent activity cycle and reflect the resource allocation scenario in the recovery plan.

As described above, the resource allocation apparatus 10 according to the first embodiment can increase the efficiency of escalation to the administration level and resource allocation to the site level by the management level, thereby allowing quick understanding of the situation and decision making, which lead to appropriate and quick recovery from the viewpoint of BCP. In addition, understanding of the background of formulation of a policy or plan is promoted in the entire organization, and self-reliant activities are also promoted.

The resource allocation apparatus 10 according to the first embodiment allocates resources between different teams, and a team having received a request for support may deny the request in order to conserve the resources of the team. However, the resource allocation apparatus 10 according to the first embodiment can facilitate understanding of the need for resource provision and the validity of the request for support in a general picture of the organization and therefore smooth coordination between different teams.

(System Configuration and Others)

The components of the devices shown in the drawings are conceptual functional units and are not necessarily configured physically as shown in the drawings. That is, the distribution and integration of the devices are not limited to the specific ones shown in the drawings, and all or some of the devices may be functionally or physically distributed or integrated in any unit depending on the load on or the usage of each device. All or some of the processing functions of each device can be implemented by a CPU and a program analyzed and executed by the CPU or implemented by wired logic-based hardware.

All or part of the processes described as being automatically performed in the description of this embodiment may be manually performed, and all or part of the processes described as being manually performed may be automatically performed in a well-known manner. The processing procedures, the control procedures, the specific names and the information including various kinds of data and parameters described above or shown in the drawings can be arbitrarily altered unless otherwise specified.

(Program)

A program can be created which describes in a computer-readable language a process performed by the resource allocation apparatus according to the embodiment described above. For example, a resource allocation program can be created which describes in a computer-readable language the process performed by the resource allocation apparatus 10 according to the embodiment. In that case, the same effects as those of the embodiment described above can be achieved by a computer executing the resource allocation program. Furthermore, the same process as that in the embodiment described above can also be implemented by recording the resource allocation program in a computer-readable recording medium, loading the resource allocation program recorded in the recording medium into a computer, and the computer executing the resource allocation program.

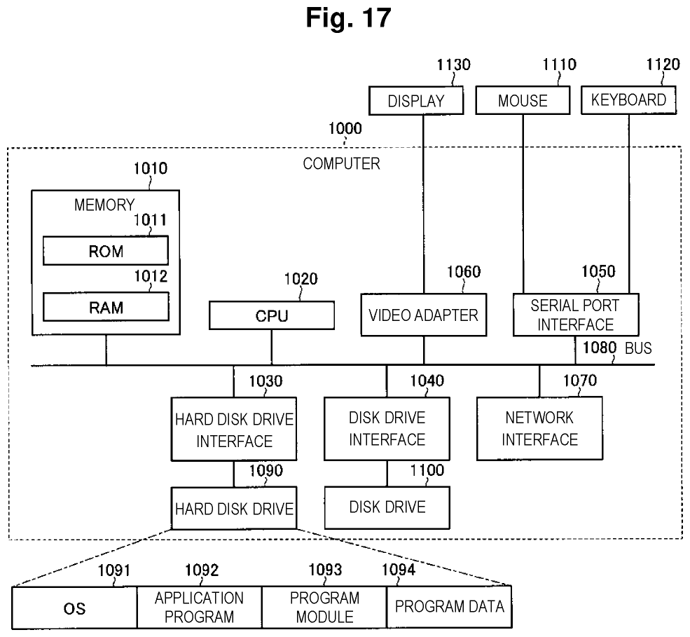

FIG. 17 is a diagram showing a computer that executes the resource allocation program. As illustrated in FIG. 17, a computer 1000 includes a memory 1010, a CPU 1020, a hard disk drive interface 1030, a disk drive interface 1040, a serial port interface 1050, a video adapter 1060 and a network interface 1070, which are connected to each other by a bus 1080.

As illustrated in FIG. 17, the memory 1010 includes a read only memory (ROM) 1011 and a RAM 1012. The ROM 1011 stores a boot program, such as a basic input output system (BIOS). As illustrated in FIG. 17, the hard disk drive interface 1030 is connected to a hard disk drive 1090. As illustrated in FIG. 17, the disk drive interface 1040 is connected to a disk drive 1100. A removable storage medium, such as a magnetic disk or an optical disk, is inserted into the disk drive 1100. As illustrated in FIG. 17, the serial port interface 1050 is connected to a mouse 1110 and a keyboard 1120, for example. As illustrated in FIG. 17, the video adapter 1060 is connected to a display 1130, for example.

As illustrated in FIG. 17, the hard disk drive 1090 stores an OS 1091, an application program 1092, a program module 1093 and program data 1094, for example. That is, the resource allocation program described above is stored in the hard disk drive 1090, for example, as a program module that describes commands to be executed by the computer 1000.

The various kinds of data in the embodiment described above are stored in the memory 1010 or the hard disk drive 1019, for example, as program data. The CPU 1020 then loads, if needed, the program module 1093 or program data 1094 stored in the memory 1010 or hard disk drive 1090 into the RAM 1012 and performs the various kinds of processing procedures.

The program module 1093 and program data 1094 relating to the resource allocation program are not always stored in the hard disk drive 1090 but may be stored in a removable storage medium and read by the CPU 1020 via a disk drive or the like. Alternatively, the program module 1093 and program data 1094 relating to the resource allocation program may be stored in another computer connected to the computer over a network (such as a local area network (LAN) or a wide area network (WAN)) and read by the CPU 1020 via the network interface 1070.

### REFERENCE SIGNS LIST

10 resource allocation apparatus
11 storage unit
11a operation plan accumulation part
11b task accumulation part
11c mission pack accumulation part
11d risk factor accumulation part
11e recovery plan accumulation part
12 control unit
12a operation plan management part
12b task management part
12c mission classification part
12d risk estimation part
12e resource allocation part
20 client terminal
30 network

1. A resource allocation apparatus comprising:
a mission classifier configured to classify a task created from a crisis response operation plan into any of a plurality of missions set based on a critical function in the event of a crisis event;
a risk estimator configured to estimate a risk for each mission or for each team that performs the task based on a progress of the task classified into the mission by the mission classifier; and
a resource allocator configured to create a resource allocation scenario according to the risk estimated by the risk estimator.

2. The resource allocation apparatus according to claim 1, wherein the mission classifier classifies the task into any of the missions based on a content of the task using a classifier obtained in advance by learning using natural language processing.

3. The resource allocation apparatus according to claim 1, wherein the risk estimator extracts a risk of each mission based on a number of tasks that are not started, a temporal variation of the number of tasks that are not started, or a number of tasks whose deadlines have passed as progresses of tasks.

4. The resource allocation apparatus according to claim 1, wherein the resource allocator creates an allocation scenario that allocates a resource to a mission that is determined to be a mission having a risk based on the risk estimated by the risk estimator.

5. A computer-implemented resource allocation method for allocating resources, comprising:
classifying, by a mission classifier, a task created from a crisis response operation plan into any of a plurality of missions set based on a critical function in the event of a crisis event;
estimating, by a risk estimator, a risk for each mission or for each team that performs the task based on a progress of the task classified into the mission in the classify; and
creating, by a resource allocator, a resource allocation scenario according to the risk estimated in the estimating of the risk.

6. A computer-readable non-transitory recording medium storing computer-executable program instruction that when executed by a processor cause a computer system to:
classify, by a mission classifier, a task created from a crisis response operation plan into any of a plurality of missions set based on a critical function in the event of a crisis event;
estimate, by a risk estimator, a risk for each mission or for each team that performs the task based on a progress of the task classified into the mission in the classifying of the mission; and
create, by a resource allocator, a resource allocation scenario according to the risk estimated in the estimating of the risk.

7. The resource allocation apparatus according to claim 1, wherein the risk estimator estimates the risk for each mission or for each team that performs the task based on a priority of the task, wherein the priority includes at least one of urgent or important.

8. The resource allocation apparatus according to claim 1, wherein the crisis response operation plan includes a checklist with a status associated with the task.

9. The computer-implemented method according to claim 5, wherein the mission classifier classifies the task into any of the missions based on a content of the task using a classifier obtained in advance by learning using natural language processing.

10. The computer-implemented method according to claim 5, wherein the risk estimator extracts a risk of each mission based on a number of tasks that are not started, a temporal variation of the number of tasks that are not started, or a number of tasks whose deadlines have passed as progresses of tasks.

11. The computer-implemented method according to claim 5, wherein the resource allocator creates an allocation scenario that allocates a resource to a mission that is determined to be a mission having a risk based on the risk estimated by the risk estimator.

12. The computer-implemented method according to claim 5, wherein the risk estimator estimates the risk for each mission or for each team that performs the task based on a priority of the task, wherein the priority includes at least one of urgent or important.

13. The computer-implemented method according to claim 5, wherein the crisis response operation plan includes a checklist with a status associated with the task.

14. The computer-readable non-transitory recording medium according to claim 6, wherein the mission classifier classifies the task into any of the missions based on a content of the task using a classifier obtained in advance by learning using natural language processing.

15. The computer-readable non-transitory recording medium according to claim 6, wherein the risk estimator extracts a risk of each mission based on a number of tasks that are not started, a temporal variation of the number of tasks that are not started, or a number of tasks whose deadlines have passed as progresses of tasks.

16. The computer-readable non-transitory recording medium according to claim 6, wherein the resource allocator creates an allocation scenario that allocates a resource to a mission that is determined to be a mission having a risk based on the risk estimated by the risk estimator.

17. The computer-readable non-transitory recording medium according to claim 6, wherein the risk estimator estimates the risk for each mission or for each team that performs the task based on a priority of the task, wherein the priority includes at least one of urgent or important.

18. The computer-readable non-transitory recording medium according to claim 6, wherein the crisis response operation plan includes a checklist with a status associated with the task.
